(19) United States
(12) Patent Application Publication
(10) Pub. No.: US 2026/0064111 A1
(43) Pub. Date: Mar. 5, 2026

(54) UNMANNED AERIAL VEHICLE CONTROL METHOD, REMOTE-CONTROL DEVICE, SYSTEM, AND STORAGE MEDIUM

(71) Applicant: ARASHI VISION INC., Shenzhen (CN)

(72) Inventors: Xi GAO, Shenzhen (CN); Jingjing JI, Shenzhen (CN)

(73) Assignee: ARASHI VISION INC., Shenzhen (CN)

(21) Appl. No.: 19/286,244

(22) Filed: Jul. 31, 2025

Related U.S. Application Data
(63) Continuation of application No. PCT/CN2024/116918, filed on Sep. 4, 2024.

(51) Int. Cl. G05D 1/223; B64U 20/87; B64U 101/30; G05D 1/686; G05D 109/25; H04N 23/695

(52) U.S. Cl. CPC G05D 1/223; G05D 1/686; H04N 23/695; B64U 20/87; B64U 2101/30; B64U 2201/20; G05D 2109/254

(57) ABSTRACT

In some aspects, a method for controlling an unmanned aerial vehicle (UAV) is provided. A selfie stick mode for the UAV can be entered in response to a first operation of a remote-control device. In the selfie stick mode, in response to a somatosensory operation of the remote-control device, the UAV can be controlled to adjust a position based on the somatosensory operation. The position can be a position of the UAV relative to a holder of the remote-control device.

### CROSS-REFERENCE TO RELATED APPLICATION

This application is a continuation of International Application No. PCT/CN2024/116918, filed on Sep. 4, 2024, the entire content of which is hereby incorporated by reference in its entirety.

### BACKGROUND

The present disclosure relates, but is not limited, to a method for controlling an unmanned aerial vehicle (UAV), a remote-control device, a system, and a storage medium.

With the growth of selfie demand and the development of UAV technology, a holder of a remote-control device can control a UAV to fly via the remote-control device, so as to use the UAV for taking selfies. However, during the process of controlling the UAV for selfies, due to the complexity of the UAV's operation method, the holder of the remote-control device finds it difficult to control the UAV to capture a suitable image, resulting in poor selfie results.

### SUMMARY

The present disclosure provides a UAV control method, a remote-control device, a system, and a storage medium.

A first aspect of the present disclosure provides a method for controlling a UAV, the method includes:
in response to a first operation of a remote-control device, controlling the UAV to enter a selfie stick mode; and
in the selfie stick mode, in response to a somatosensory operation of the remote-control device, controlling the UAV to adjust a position based on the somatosensory operation, the position referring to a position of the UAV relative to a holder of the remote-control device.

A second aspect of the present disclosure provides a method for controlling a UAV, the method includes:
in response to a target operation of a remote-control device, controlling the UAV to perform multiple different stages of motion based on the target operation to adjust a distance between the UAV and a holder of the remote-control device.

A third aspect of the present disclosure provides a remote-control device, including a memory and a processor, the memory storing a computer program, and when instructions of the computer program are executed by the processor, the processor is configured to:
in response to a first operation of the remote-control device, control a UAV to enter a selfie stick mode; and
in the selfie stick mode, in response to a somatosensory operation of the remote-control device, control the UAV to adjust a position based on the somatosensory operation, the position referring to a position of the UAV relative to a holder of the remote-control device.

A fourth aspect of the present disclosure provides a remote-control device, including a memory and a processor, the memory storing a computer program, and when the computer program instructions are executed by the processor, the processor is configured to:
in response to a target operation of a remote-control device, control the UAV to perform multiple different stages of motion based on the target operation to adjust a distance between the UAV and a holder of the remote-control device.

A fifth aspect of the present disclosure provides a UAV control system, and the UAV control system includes a remote-control device and a UAV;
the remote-control device is configured to, in response to a first operation of the remote-control device, send a first control signal to the UAV, and in the selfie stick mode, in response to a somatosensory operation of the remote-control device, send a second control signal to the UAV; and
the UAV is configured to, based on the received first control signal, enter the selfie stick mode, and in the selfie stick mode, based on the received second control signal, adjust a position, the position referring to a position of the UAV relative to a holder of the remote-control device.

A sixth aspect of the present disclosure provides a UAV control system, and the UAV control system includes a remote-control device and a UAV;
the remote-control device is configured to, in response to a target operation of the remote-control device by a holder of the remote-control device, send a first target signal to the UAV; and
the UAV is configured to, based on the received first target signal, perform multiple different stages of motion to adjust a distance between the UAV and the holder of the remote-control device.

A seventh aspect of the present disclosure provides a computer-readable storage medium storing a computer program, when the computer program is executed by a processor, the steps of the method according to the first aspect or the second aspect are implemented.

In the UAV control method, remote-control device, system, and storage medium provided by the embodiments of the present disclosure, in response to a first operation of the remote-control device, the holder of the remote-control device needs to take selfies using the UAV, and the UAV is controlled to enter the selfie stick mode. In the selfie stick mode, in response to a somatosensory operation of the remote-control device, the UAV is controlled to adjust a position based on the somatosensory operation. Since, in the selfie stick mode, the position of the UAV can be adjusted by the somatosensory operation to take selfies from different positions, it avoids the difficulty for the holder of the remote-control device to control the UAV to capture a suitable image, thereby improving the selfie result and reducing the complexity of taking selfies.

Other aspects will become apparent after reading and understanding the drawings and detailed description.

### BRIEF DESCRIPTION OF DRAWINGS

The accompanying drawings, which are incorporated in and constitute a part of the specification, illustrate embodiments of the present disclosure and, together with the description, serve to explain the principles of the embodiments of the present disclosure. In these drawings, same/similar reference numerals are used to indicate same/similar elements. The drawings described below are some embodiments of the present disclosure, and not all embodiments. Those skilled in the art can obtain other drawings based on these drawings without creative efforts.

FIG. 1 is a flowchart of a UAV control method according to some embodiments of the present disclosure.

FIG. 2 is a schematic diagram of a UAV control system according to some embodiments of the present disclosure.

FIG. 3 is a schematic diagram of a UAV control process according to some embodiments of the present disclosure.

FIG. 4 is a schematic diagram showing the spherical trajectory with the sphere center during a UAV control process according to some embodiments of the present disclosure.

FIG. 5A is a schematic diagram showing a UAV control process by the remote-control device according to some embodiments of the present disclosure.

FIG. 5B is another schematic diagram showing a UAV control process by the remote-control device according to some embodiments of the present disclosure.

FIG. 6 is a first flowchart of a UAV control method according to some embodiments of the present disclosure.

FIG. 7 is a second flowchart of a UAV control method according to some embodiments of the present disclosure.

FIG. 8 is a third flowchart of a UAV control method according to some embodiments of the present disclosure.

FIG. 9 is a block diagram of a remote-control device according to some embodiments of the present disclosure.

The present disclosure will be described with reference to the accompanying drawings.

### DETAILED DESCRIPTION

The following will clearly and completely describe the technical solutions in the disclosed embodiments with reference to the drawings in the embodiments of the present disclosure. Obviously, the embodiments described are only part of the embodiments of the present disclosure, and not all embodiments. Based on the embodiments in the present disclosure, all other embodiments obtained by those skilled in the art without creative efforts shall fall within the scope of protection of the present disclosure. It should be noted that, unless there is a conflict, the embodiments in the present disclosure and the features in the embodiments can be combined with each other in any way.

With the growth of selfie demand and the development of unmanned aerial vehicle (UAV) technology, a holder of a remote-control device can control a UAV to fly via the remote-control device, so as to use the UAV for taking selfies. When the holder of the remote-control device takes selfies using the UAV, it is necessary to first learn how to operate the UAV via the remote-control device, and to constantly pay attention to the position of the UAV during the selfie process to avoid being unable to take selfies from a suitable angle. Since, during the process of controlling the UAV for selfies, the holder of the remote-control device may operate improperly, causing the distance between the UAV and the holder of the remote-control device to change, it is difficult to control the UAV to capture a suitable image, resulting in poor selfie results.

In view of this, the present disclosure provides a method for controlling a UAV. When it is necessary for the UAV to take selfies of the holder of the remote-control device, the UAV is controlled to enter a selfie stick mode, and the UAV is controlled to adjust a position in response to a somatosensory operation of the remote-control device by the holder of the remote-control device. In the present disclosure, the term “somatosensory operation” may refer to a control method in which the user operates the remote-control device through human physical movement/user interaction, which may result from motions of the user's body (e.g., hand, head, or arm). In some examples, the somatosensory operation may include tilting, rotating, or swinging the remote-control device. These motions can be detected by one or more onboard sensors, such as inertial measurement units (IMUs) (e.g., accelerometers or gyroscopes), and translated into commands for controlling the UAV.

Since the somatosensory operation is simple to operate, the holder of the remote-control device can adjust the position of the UAV to take selfies from different positions without learning complex operation methods, and the UAV can maintain a fixed distance from the holder of the remote-control device, thereby improving the selfie result and reducing the complexity of taking selfies.

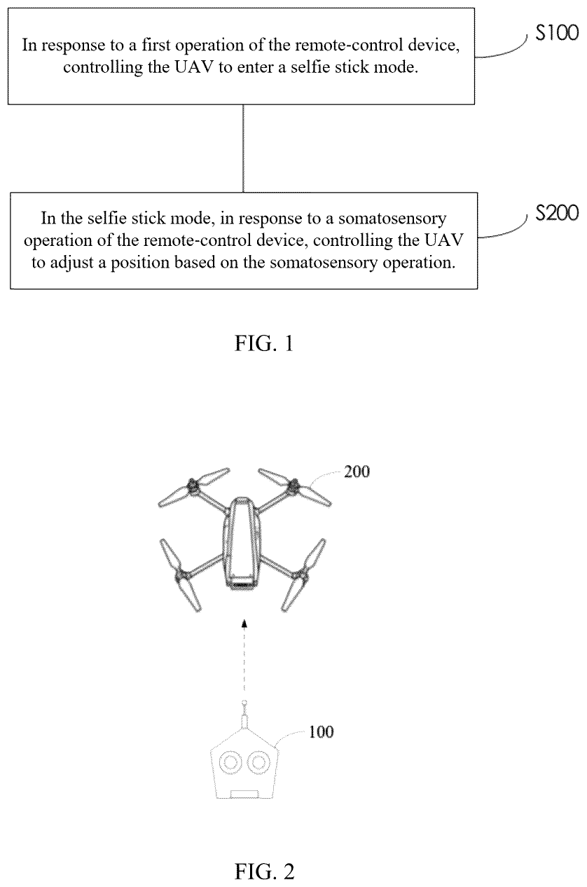

In some aspects, the present disclosure provides a method for controlling a UAV. As shown in FIG. 1, the method includes the following steps.

S100: In response to a first operation of the remote-control device, controlling the UAV to enter a selfie stick mode.

S200: In the selfie stick mode, in response to a somatosensory operation of the remote-control device, controlling the UAV to adjust a position based on the somatosensory operation.

In some embodiments, in response to the first operation of the remote-control device, the holder of the remote-control device needs to take selfies using the UAV, and the UAV is controlled to enter the selfie stick mode. In the present disclosure, the term “selfie stick mode” may refer to a UAV control mode activated when the holder of the remote-control device intends to take selfie(s) using the UAV. In the selfie stick mode, the UAV may behave like a “virtual” selfie stick, enabling the user to capture photos or videos from optimal angles with minimal manual control. In some examples, under this mode, the holder may intuitively adjust the position of UAV around the holder through the somatosensory operation(s). In some examples, under this mode, the relative distance and orientation of the UAV with respect to the holder of the remote-control device may remain fixed or unchanged′.

In the selfie stick mode, in response to a somatosensory operation of the remote-control device, the UAV is controlled to adjust a position based on the somatosensory operation. Since, in the selfie stick mode, the position of the UAV can be adjusted by the somatosensory operation to take selfies from different positions, it avoids the difficulty for the holder of the remote-control device to control the UAV to capture a suitable image, thereby improving the selfie result and reducing the complexity of taking selfies.

In some embodiments, the UAV may capture images of the holder of the remote-control device via its own camera, or may capture images of the holder of the remote-control device via a mounted camera.

In some embodiments, the remote-control device is provided with an inertial measurement unit (IMU), which can detect acceleration information and angular velocity information to obtain relative pose information of the remote-control device that changes under a first somatosensory operation, so as to adjust the position of the UAV via the relative pose information to capture images of the holder of the remote-control device.

In some embodiments, after controlling the UAV to enter the selfie stick mode in step S100, the UAV may identify the holder of the remote-control device via a target detection algorithm, so as to capture images of the holder of the remote-control device.

In some embodiments, as shown in FIG. 2, the UAV control system includes a remote-control device 100 and a UAV 200. After the user operates the remote-control device 100, the remote-control device 100 sends a signal to the UAV 200. The UAV 200 performs a corresponding action based on the signal sent by the remote-control device 100.

In some embodiments, the controlling the UAV to adjust the position based on the somatosensory operation of the remote-control device in step S200 is determined as follows.

In response to a somatosensory operation of the remote-control device, controlling the UAV to move from an initial position to a target position, the initial position being a position of the UAV before the somatosensory operation, and the target position being a position of the UAV pointed to when the somatosensory operation stops.

In the embodiment, a trajectory of moving from the initial position to the target position is a curved trajectory. The curved trajectory is a part of a spherical trajectory. A sphere center of the spherical trajectory is a position of the holder of the remote-control device, and a radius of the spherical trajectory is a distance between the UAV and the holder of the remote-control device.

In some embodiments, since the holder of the remote-control device needs to move the UAV by performing a somatosensory operation on the remote-control device to change the position of the UAV, in response to the somatosensory operation of the remote-control device, the UAV is controlled to move from the initial position before the somatosensory operation to the target position pointed to when the somatosensory operation stops. Since the trajectory from the initial position to the target position is a curved trajectory, and the curved trajectory is a part of a spherical trajectory, the UAV can capture images by circling around the holder of the remote-control device. By changing the position of the UAV through the somatosensory operation, the UAV can capture images of the holder of the remote-control device from different positions to achieve different effects, thereby improving the selfie result.

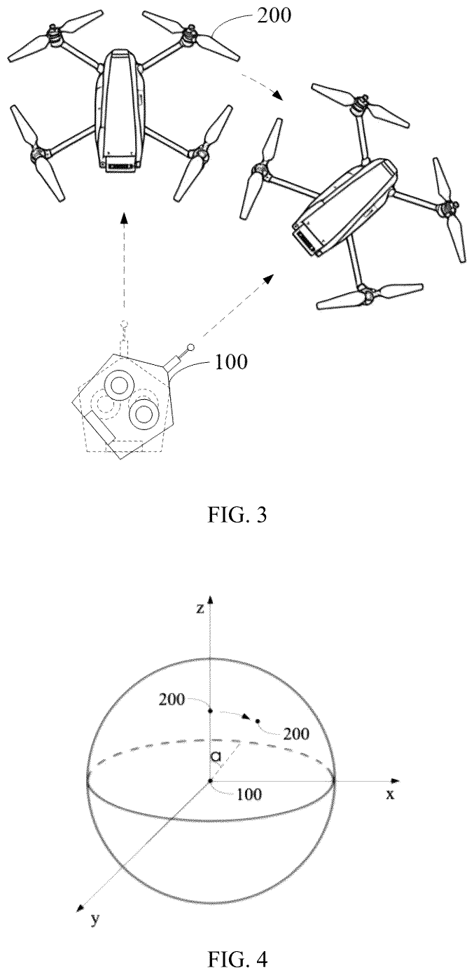

In some embodiments, as shown in FIG. 3, in response to a somatosensory operation of the remote-control device 100, the UAV 200 moves from the initial position to the target position to capture images of the holder of the remote-control device from different positions.

In some embodiments, the controlling the UAV to move from the initial position to the target position in response to the somatosensory operation of the remote-control device as described above may be determined as follows.

In response to the somatosensory operation of the remote-control device, controlling the UAV to follow the somatosensory operation of the remote-control device along the curved trajectory from the initial position to the target position, where a relative rotation angle of the UAV and the remote-control device remains unchanged.

In some embodiments, since the holder of the remote-control device needs to move the UAV by performing a somatosensory operation on the remote-control device to change the position of the UAV, in response to the somatosensory operation of the remote-control device, the UAV is controlled to follow the somatosensory operation of the remote-control device along the curved trajectory from the initial position to the target position, and the position of the UAV is adjusted while the relative rotation angle remains unchanged. Since the somatosensory operation lasts for a certain period of time, the UAV follows the remote-control device in real time during the operation of the remote-control device to keep the relative rotation angle unchanged. By moving the UAV with the relative rotation angle unchanged through the somatosensory operation, the angle of movement of the UAV along the spherical trajectory can be controlled by the rotation angle of the remote-control device, so that the UAV can capture images of the holder of the remote-control device from different positions, and the movement angle of the UAV can be consistent with the rotation angle of the remote-control device, thereby improving the selfie result. Moreover, since only the remote-control device needs to be rotated to change the shooting angle of the UAV, the complexity of taking selfies is reduced.

In some embodiments, as shown in FIG. 4, the sphere center of the spherical trajectory is located at the origin of the spatial coordinate system. When the remote-control device 100 rotates α degrees clockwise or counterclockwise along the z-axis in the xy-plane, the UAV 200 moves along the curved trajectory corresponding to a degrees clockwise or counterclockwise along the z-axis in a plane parallel to the xy-plane of the spherical trajectory with respect to the origin. When the remote-control device 100 rotates β degrees clockwise or counterclockwise along the y-axis in the xz-plane, the UAV 200 moves along the curved trajectory corresponding to β degrees clockwise or counterclockwise along the y-axis in a plane parallel to the xz-plane of the spherical trajectory with respect to the origin. When the remote-control device 100 rotates γ degrees clockwise or counterclockwise along the x-axis in the yz-plane, the UAV 200 moves along the curved trajectory corresponding to γ degrees clockwise or counterclockwise along the x-axis in a plane parallel to the yz-plane of the spherical trajectory with respect to the origin.

In some embodiments, the controlling the UAV to move from the initial position to the target position in response to the somatosensory operation of the remote-control device as described above may also be determined as follows.

When the somatosensory operation is a rotation operation of the remote-control device on a target plane, controlling the UAV to move along the curved trajectory on the target plane or a plane parallel to the target plane.

In some embodiments, since only the remote-control device needs to be rotated on the target plane, the UAV can be moved on the corresponding plane to change the position of the UAV, thereby reducing the complexity of taking selfies.

In some embodiments, a central angle corresponding to the curved trajectory of the UAV moving on the plane is positively correlated with an angle of the remote-control device rotating on the target plane.

In some embodiments, by making the central angle corresponding to the curved trajectory of the UAV moving on the plane positively correlated with the angle of the remote-control device rotating on the target plane, the holder of the remote-control device can move the UAV to a farther position by increasing the rotation amount to suit the holder's habits, thereby reducing the complexity of taking selfies.

In some embodiments, a distance of the UAV moving on the plane is positively correlated with the angle of the remote-control device rotating on the target plane.

In some embodiments, by making the distance of the UAV moving on the plane positively correlated with the angle of the remote-control device rotating on the target plane, the holder of the remote-control device can move the UAV to a farther position by increasing the rotation amount to suit the holder's habits, thereby reducing the complexity of taking selfies.

In some embodiments, a speed of the UAV moving on the plane is positively correlated with a speed of the remote-control device rotating on the target plane.

In some embodiments, by making the speed of the UAV moving on the plane positively correlated with the speed of the remote-control device rotating on the target plane, the holder of the remote-control device can make the UAV move faster by increasing the rotation speed to suit the holder's habits, thereby reducing the complexity of taking selfies.

In some embodiments, the speed of the UAV moving on the plane is a preset speed.

In some embodiments, by making the speed of the UAV moving on the plane a preset speed, it is possible to avoid the UAV moving too fast or too slow and affecting the shooting by the holder of the remote-control device, thereby reducing the complexity of taking selfies.

In some embodiments, during the rotation of the remote-control device, the speed of rotation of the remote-control device can be detected, and whether the somatosensory operation is valid can be determined according to the speed of rotation of the remote-control device to avoid the UAV malfunctioning due to misoperation by the holder of the remote-control device. For example, when the speed of rotation of the remote-control device is 30°/s, the somatosensory operation is determined to be valid. When the speed of rotation of the remote-control device is 180°/s, the somatosensory operation is determined to be invalid. When the somatosensory operation is invalid, the UAV is not controlled.

In some embodiments, the method for controlling a UAV further includes:
in the selfie stick mode, in response to a movement operation of the remote-control device, controlling the UAV to move following the movement operation of the remote-control device, and maintaining a distance between the UAV and the remote-control device unchanged during the movement.

In some embodiments, by making the UAV move following the remote-control device via a movement operation and maintaining the distance between the UAV and the remote-control device unchanged, the UAV can capture images with different backgrounds without changing the distance, thereby improving the selfie result.

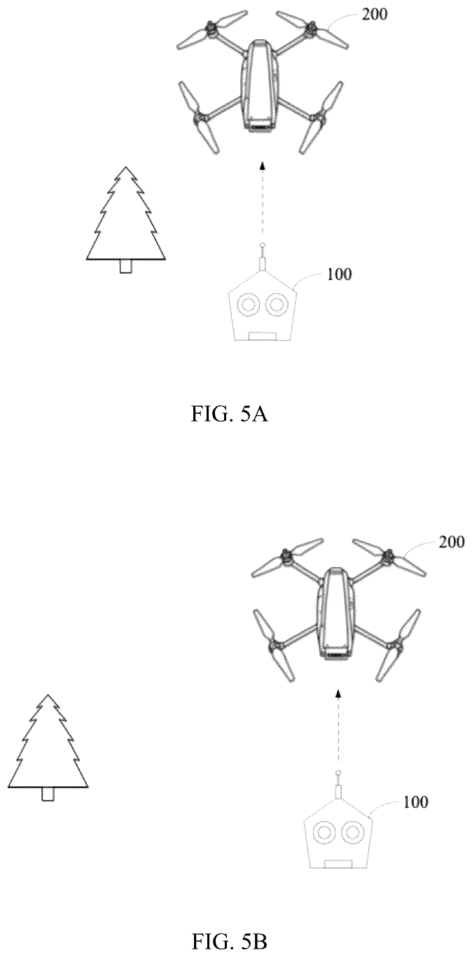

In some embodiments, as shown in FIGS. 5A and 5B, during the process in which the holder of the remote-control device controls the UAV 200 via the remote-control device 100, there are certain reference objects (such as trees) nearby. After the holder of the remote-control device performs a movement operation of the remote-control device 100 away from the reference object, the UAV 200 moves following the remote-control device 100 while maintaining the distance between the UAV 200 and the remote-control device 100 unchanged.

In some embodiments, the method for controlling a UAV further includes:
in the selfie stick mode, in response to a composite operation of the remote-control device, the composite operation including a somatosensory operation and a movement operation, controlling the UAV to adjust the position and the distance simultaneously based on the composite operation, and maintaining a relative rotation angle of the UAV and the remote-control device unchanged during the adjustment, while maintaining the distance between the UAV and the remote-control device unchanged.

In some embodiments, since the holder of the remote-control device needs to move the UAV by performing a somatosensory operation on the remote-control device to change the position of the UAV, and needs to move the UAV by performing a movement operation on the remote-control device to change the background of the shot, in response to the composite operation of the remote-control device, the UAV is controlled to adjust the position and the distance simultaneously based on the composite operation, so as to adjust the position of the UAV while maintaining the relative rotation angle and the distance unchanged. By moving the UAV with the relative rotation angle and the distance unchanged through the composite operation, the movement of the UAV can be controlled by the rotation angle and the movement distance of the remote-control device to capture images of the holder of the remote-control device from different positions, thereby improving the selfie result.

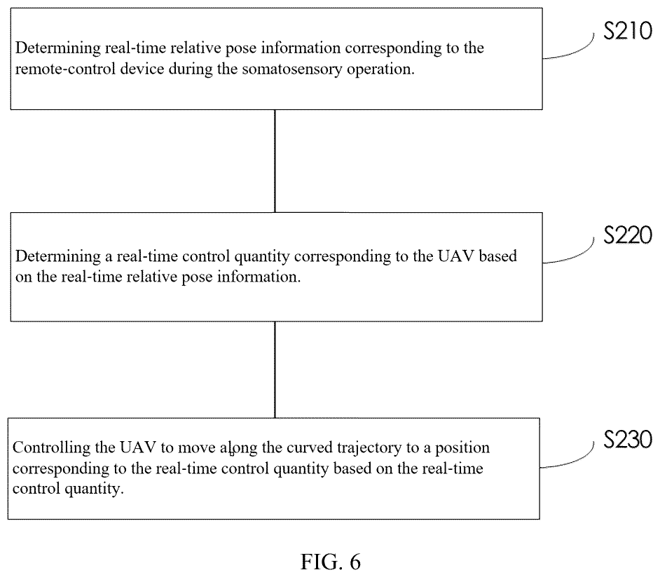

In some embodiments, as shown in FIG. 6, the controlling the UAV to move from the initial position to the target position in response to the somatosensory operation of the remote-control device as described above may further be determined as follows.

S210: Determining real-time relative pose information corresponding to the remote-control device during the somatosensory operation.

S220: Determining a real-time control quantity corresponding to the UAV based on the real-time relative pose information.

S230: Controlling the UAV to move along the curved trajectory to a position corresponding to the real-time control quantity based on the real-time control quantity.

In some embodiments, the real-time relative pose information corresponding to the remote-control device during the somatosensory operation is determined to determine the extent to which the holder of the remote-control device needs to control the movement of the UAV. The real-time control quantity corresponding to the UAV is determined based on the real-time relative pose information, so as to convert the somatosensory operation into a real-time control quantity. The UAV is controlled to move along the curved trajectory to a position corresponding to the real-time control quantity based on the real-time control quantity, so that the UAV moves under the action of the real-time control quantity. By controlling the movement of the UAV in real time, the UAV does not need to change its inherent control method and can be applied to various types of UAVs, and it is possible to avoid delays in the movement of the UAV that affect the shooting effect, thereby improving the selfie result and the universality of selfies.

In some embodiments, the controlling the UAV to move from the initial position to the target position in response to the somatosensory operation of the remote-control device as described above may further be determined as follows:
determine real-time relative pose information corresponding to the remote-control device during the somatosensory operation; and
control the UAV to move along the curved trajectory to a position corresponding to the real-time relative pose information based on the real-time relative pose information.

In some embodiments, the controlling the UAV to move from the initial position to the target position in response to the somatosensory operation of the remote-control device as described above may further be determined as follows:
determine real-time relative pose information corresponding to the remote-control device during the somatosensory operation;
determine a control instruction corresponding to the UAV based on the real-time relative pose information; and
control the UAV to move along the curved trajectory to a position corresponding to the control instruction based on the control instruction.

In some embodiments, the determining real-time relative pose information corresponding to the remote-control device during the somatosensory operation as described above is determined as follows:
determine a real-time angle mapped to a corresponding axis for the remote-control device during the somatosensory operation, the corresponding axis including at least one of a pitch axis, a yaw axis, or a roll axis, and use the real-time angle mapped to the corresponding axis as the real-time relative pose information.

In some embodiments, since during the somatosensory operation of the remote-control device, the angle of one or more of the pitch axis, yaw axis, and roll axis of the remote-control device changes, the degree of real-time angle change can reflect the real-time relative pose information of the remote-control device. By using the real-time angle mapped to the corresponding axis as the real-time relative pose information, it is possible to determine in real time the change of the remote-control device under the somatosensory operation to control the position of the UAV, thereby improving the reliability of selfies.

In some embodiments, the rotation direction of the UAV may be the same as or opposite to the rotation direction of the remote-control device under the somatosensory operation. The rotation angle of the UAV may be the same as or positively correlated with the rotation angle of the remote-control device under the somatosensory operation.

In some embodiments, the method for controlling a UAV further includes:
in response to a pointing operation of the remote-control device, control the UAV to move to a position pointed by the pointing operation.

In some embodiments, since the holder of the remote-control device may wish the UAV to move to a target position to capture images of the holder, if this is achieved by adjusting the distance between the UAV and the holder of the remote-control device and/or the shooting angle of the UAV, a large number of operations are required and it is difficult to accurately locate. By controlling the UAV to move to a position pointed by the pointing operation, the UAV can quickly reach the target position to capture images of the holder of the remote-control device, thereby reducing the complexity of taking selfies.

In some embodiments, the position pointed by the pointing operation may be a position pointed by the side of the remote-control device facing away from the holder of the remote-control device when the holder correctly holds the remote-control device. In addition to enabling the UAV to quickly reach the target position, the pointing operation can also cause the UAV to perform corresponding movements according to changes in the pointing operation. For example, when the holder of the remote-control device performs a pointing operation of writing the letter M, the UAV performs an M-shaped movement at the target position, so that the UAV can capture images of the holder of the remote-control device in a stylish way to improve the selfie result.

In some embodiments, the first operation includes one of a sliding operation of a first sliding key in the remote-control device, a rolling operation of a first rolling key in the remote-control device, a pressing operation of a first pressing key in the remote-control device, a first clicking operation of a screen in the remote-control device, a first touch operation of the remote-control device, a first swing operation of the remote-control device, or a first voice operation of the remote-control device.

In some embodiments, since the remote-control device may be provided with physical keys, a screen, and a microphone, the selfie stick mode can be entered by operating the physical keys, screen, or microphone. By controlling the UAV to enter the selfie stick mode via a sliding operation of a first sliding key, a rolling operation of a first rolling key, a pressing operation of a first pressing key, a first clicking operation of a screen, a first touch operation, a first swing operation, or a first voice operation, the way to enter the selfie stick mode is simple, thereby reducing the complexity of taking selfies.

In some embodiments, the method for controlling a UAV further includes:
in the selfie stick mode, in response to a second operation of the remote-control device, adjusting a distance between the UAV and the holder of the remote-control device.

In some embodiments, since the holder of the remote-control device may need to adjust the distance between the UAV and the holder of the remote-control device during the process of controlling the UAV for selfies, in order to achieve better selfie results in different environments, in response to a second operation of the remote-control device, the distance between the UAV and the holder of the remote-control device is adjusted to capture images of the holder of the remote-control device from different distances. By adjusting the distance between the UAV and the holder of the remote-control device via the second operation, the image of the holder of the remote-control device in the captured image can be changed, thereby improving the selfie result.

In some embodiments, the adjusting a distance between the UAV and the holder of the remote-control device in response to the second operation of the remote-control device as described above may be determined as follows:
when the second operation is a swing operation of the remote-control device, control the UAV to perform multiple different stages of motion based on the swing operation to adjust the distance between the UAV and the holder of the remote-control device.

In some embodiments, since the holder of the remote-control device hopes to see a visually engaging movement of the UAV and hopes the UAV can capture images in a stylish way when adjusting the distance between the UAV and the holder of the remote-control device, when the second operation is a swing operation of the remote-control device, the UAV is controlled to perform multiple different stages of motion based on the swing operation to achieve an enhanced visual effect. By controlling the movement of the UAV via a swing operation, only one operation is needed for the UAV to move and capture images in a stylish way, thereby improving the selfie result and reducing the complexity of taking selfies.

In some embodiments, the controlling the UAV to perform multiple different stages of motion based on the swing operation as described above may be determined as follows:
during the swing operation, control the UAV to perform variable-speed motion along a first target trajectory away from the holder of the remote-control device; and
after the swing operation ends, control the UAV to perform constant-speed motion along a second target trajectory away from the holder of the remote-control device.

In some embodiments, during the swing operation, the remote-control device is in motion and the movement speed changes, and the UAV is controlled to perform variable-speed motion along a first target trajectory away from the holder of the remote-control device. After the swing operation ends, the remote-control device is stationary, and the UAV is controlled to perform constant-speed motion along a second target trajectory away from the holder of the remote-control device. By controlling the UAV to move at different trajectories and speeds via the swing operation, the UAV can move and capture images in a stylish way, thereby improving the selfie result and reducing the complexity of taking selfies.

In some embodiments, a speed of the variable-speed motion is positively correlated with a force of the swing operation.

In some embodiments, by making the speed of the variable-speed motion positively correlated with the force of the swing operation, the speed of the variable-speed motion of the UAV can be adjusted by the force of the swing operation, and the adjustment method conforms to the habits of the holder of the remote-control device, thereby improving the selfie result and reducing the complexity of taking selfies.

In some embodiments, under the swing operation, the relationship between the speed of the variable-speed motion and time can be preset. A proportional coefficient is set in the relationship, and the proportional coefficient is positively correlated with the force of the swing operation, so that the speed of the variable-speed motion increases as the force of the swing operation increases. The speed of the variable-speed motion may gradually increase or decrease with time. Alternatively, the speed of the variable-speed motion may be unrelated to time and only positively correlated with the force of the swing operation. For example, the speed of the variable-speed motion may be a preset speed multiplied by the proportional coefficient, and the proportional coefficient is positively correlated with the force of the swing operation. It should be understood that the above is only an example, and the method for determining the speed of the variable-speed motion is not limited to the embodiments described in the present disclosure.

It should be understood that the speed of the variable-speed motion may also be negatively correlated with or unrelated to the force of the swing operation. That is, the speed of the variable-speed motion may be a preset variable speed, which is not limited herein.

In some embodiments, the first target trajectory is determined based on the force and/or arc of the swing operation.

In some embodiments, by determining the first target trajectory based on the force and/or arc of the swing operation, the holder of the remote-control device can make the UAV perform variable-speed motion along different trajectories under different swing operations to achieve an enhanced visual effect, thereby improving the selfie result and reducing the complexity of taking selfies.

In some embodiments, the first target trajectory may be a preset trajectory under different forces and/or arcs of the swing operation. For example, when the force and/or arc of the swing operation is within a first preset range, the first target trajectory is a linear trajectory. When the force and/or arc of the swing operation is within a second preset range, the first target trajectory is an arc trajectory. When the force and/or arc of the swing operation is within a third preset range, the first target trajectory is a spiral trajectory. Alternatively, the first target trajectory may be a curved trajectory, and the radius of the curved trajectory is positively correlated with the force and/or arc of the swing operation. Alternatively, the first target trajectory may also be a spiral trajectory, and the radius of the spiral trajectory is positively correlated with the force and/or arc of the swing operation. The arc of the swing operation may be the arc of the swing of the remote-control device or the amplitude of the swing of the remote-control device. It should be understood that the above is only an example, and the method for determining the first target trajectory is not limited in the present disclosure.

It should be understood that the first target trajectory may also be unrelated to the force and arc of the swing operation. That is, the first target trajectory may be a preset trajectory, such as a linear trajectory, an arc trajectory, a spiral trajectory, etc., which is not limited herein.

In some embodiments, a speed of the constant-speed motion is determined based on a speed of the variable-speed motion and/or the first target trajectory.

In some embodiments, by making the speed of the constant-speed motion determined based on the speed of the variable-speed motion and/or the first target trajectory, the movement speeds of the UAV in the two different stages are correlated to achieve an enhanced visual effect, and the two stages of movement can be smoothly connected, thereby improving the selfie result and reducing the complexity of taking selfies.

In some embodiments, the speed of the constant-speed motion may be the speed at the end of the variable-speed motion, the average speed of the variable-speed motion, the initial speed of the variable-speed motion, etc., or may be the ratio of the distance of the first target trajectory to a preset value, or may be the average value of the speed at the end of the variable-speed motion and the ratio of the distance of the first target trajectory to a preset value, etc. It should be understood that the above is only an example, and the method for determining the speed of the constant-speed motion is not limited to the embodiments described in the present disclosure.

It should be understood that the speed of the constant-speed motion may also be unrelated to the speed of the variable-speed motion and the first target trajectory. That is, the speed of the constant-speed motion may be a preset fixed speed, which is not limited herein.

In some embodiments, the second target trajectory is determined based on the first target trajectory.

In some embodiments, by making the second target trajectory determined based on the first target trajectory, the movement trajectories of the UAV in the two different stages are correlated to achieve an enhanced visual effect, and the two stages of movement can be smoothly connected, thereby improving the selfie result and reducing the complexity of taking selfies.

In some embodiments, the second target trajectory may be the same as or different from the first target trajectory. For example, when the first target trajectory is a curved trajectory, the second target trajectory may be a linear trajectory or a spiral trajectory. When the first target trajectory is a linear trajectory, the second target trajectory may be a curved trajectory or a spiral trajectory. When the first target trajectory is a spiral trajectory, the second target trajectory may be a linear trajectory or a curved trajectory. Alternatively, the second target trajectory may be a linear trajectory along the direction at the end of the first target trajectory. It should be understood that the above is only an example, and the method for determining the second target trajectory is not limited to the embodiments described in the present disclosure.

It should be understood that the second target trajectory may also be unrelated to the first target trajectory. That is, the second target trajectory may be a preset trajectory, such as a linear trajectory, an arc trajectory, a spiral trajectory, etc., which is not limited herein.

In some embodiments, the controlling the UAV to perform multiple different stages of motion based on the swing operation as described above may also be determined as follows:
during the swing operation, control the UAV to perform variable-speed motion along a curved trajectory, a radius of the curved trajectory gradually increasing with a duration of the swing operation, and a central angle of the curved trajectory being a central angle of the swing operation; and
after the swing operation ends, control the UAV to perform constant-speed motion along a linear trajectory away from the holder of the remote-control device.

In some embodiments, during the swing operation, the remote-control device is in motion and the movement speed changes, and the UAV is controlled to perform variable-speed motion along a curved trajectory whose radius gradually increases with the duration of the swing operation. After the swing operation ends, the remote-control device is stationary, and the UAV is controlled to perform constant-speed motion along a linear trajectory away from the holder of the remote-control device so that the UAV moves based on inertia. By controlling the UAV to move at different trajectories and speeds via the swing operation, the UAV can move and capture images in a stylish way, thereby improving the selfie result and reducing the complexity of taking selfies.

It should be understood that, during the swing operation, the UAV may also perform constant-speed motion. After the swing operation ends, the UAV may also perform variable-speed motion, which is not limited herein.

In some embodiments, the speed of the variable-speed motion may be positively correlated, negatively correlated, or unrelated to the force of the swing operation. The speed of the constant-speed motion may be determined based on the speed of the variable-speed motion or may be a preset speed.

In some embodiments, the second operation may be a swing operation, a waving operation, a movement operation, etc., in addition to a swing operation.

In some embodiments, the adjusting a distance between the UAV and the holder of the remote-control device in response to the second operation of the remote-control device as described above may also be determined as follows:
in response to the second operation, control the UAV to move in a direction of a connecting line between the UAV and the holder of the remote-control device to adjust the distance between the UAV and the holder of the remote-control device.

In some embodiments, by moving the remote-control device forward and backward via the second operation to control the UAV to move in a direction of a connecting line between the UAV and the holder of the remote-control device, the UAV can simulate the extension and retraction of a real selfie stick to adjust the selfie distance without changing the angle, thereby reducing the complexity of taking selfies.

In some embodiments, a speed of the UAV is positively correlated with a movement distance.

In some embodiments, when the UAV moves in a direction of a connecting line between the UAV and the holder of the remote-control device, the UAV can move at different speeds. By making the speed of the UAV positively correlated with the movement distance, the speed of the UAV can be adapted to the movement distance to enable the holder of the remote-control device to capture images, thereby improving the selfie result.

In some embodiments, the speed of the UAV is a preset speed.

In some embodiments, by setting the speed of the UAV as a preset speed, it is possible to avoid the UAV moving too fast or too slow and affecting the shooting by the holder of the remote-control device, thereby reducing the complexity of taking selfies.

In some embodiments, the second operation includes one of a sliding operation of a second sliding key in the remote-control device, a rolling operation of a second rolling key in the remote-control device, a pressing operation of a second pressing key in the remote-control device, a second clicking operation of a screen in the remote-control device, a second touch operation of the remote-control device, a second swing operation of the remote-control device, or a second voice operation of the remote-control device.

In some embodiments, since the remote-control device may be provided with physical keys, a screen, and a microphone, the distance between the UAV and the holder of the remote-control device can be adjusted by operating the physical keys, screen, or microphone. By performing a sliding operation of a second sliding key, a rolling operation of a second rolling key, a pressing operation of a second pressing key, a second clicking operation of a screen, a second touch operation, a second swing operation, or a second voice operation, the UAV can move in a direction of a connecting line between the UAV and the holder of the remote-control device under each operation, and the movement distance can be determined according to the degree of each operation. By adjusting the distance between the UAV and the holder of the remote-control device in different ways, it is convenient for holders of the remote-control device who are not accustomed to the first somatosensory operation to operate, and the UAV can simulate the extension and retraction of a real selfie stick to adjust the selfie distance without changing the angle, thereby reducing the complexity of taking selfies.

In some embodiments, after controlling the UAV to enter the selfie stick mode in step S100, the UAV and the remote-control device exchange position information with each other, so that each can determine the relative distance and angle. When adjusting the distance between the UAV and the holder of the remote-control device by performing a sliding operation of a second sliding key, a rolling operation of a second rolling key, a pressing operation of a second pressing key, a second clicking operation of a screen, a second touch operation, a second swing operation, or a second voice operation, the relative distance and angle can be used. For example, the sliding operation of a second sliding key, the rolling operation of a second rolling key, the pressing operation of a second pressing key, the second clicking operation of a screen, the second touch operation, the second swing operation, or the second voice operation can be converted into a distance in the horizontal direction and a distance in the vertical direction, and the UAV is controlled to move in a direction of a connecting line between the UAV and the holder of the remote-control device.

In some embodiments, the method for controlling a UAV further includes:
in the selfie stick mode, in response to a third operation of the remote-control device, switch the selfie stick mode to another mode based on the third operation, the another mode being a mode other than the selfie stick mode.

In some embodiments, since the holder of the remote-control device does not need the UAV to capture images by circling in special environments and wishes to change the shooting mode of the UAV, in response to a third operation of the remote-control device, the selfie stick mode is switched to another mode, so that the UAV moves in another mode to capture images of the holder of the remote-control device. By enabling the UAV to capture images of the holder of the remote-control device in a corresponding way in another mode, the UAV can capture images of the holder of the remote-control device in different modes, thereby improving the selfie result.

In some embodiments, the third operation comprises one of a sliding operation of a third sliding key in the remote-control device, a rolling operation of a third rolling key in the remote-control device, a pressing operation of a third pressing key in the remote-control device, a third clicking operation of a screen in the remote-control device, a third touch operation of the remote-control device, a third swing operation of the remote-control device, and a third voice operation of the remote-control device.

In some embodiments, since the remote-control device may be provided with physical keys, a screen, and a microphone, the selfie stick mode can be switched to another mode by operating the physical keys, screen, or microphone. By controlling the UAV to enter another mode via a sliding operation of a third sliding key, a rolling operation of a third rolling key, a pressing operation of a third pressing key, a third clicking operation of a screen, a third touch operation, a third swing operation, or a third voice operation, the way to enter another mode is simple, thereby reducing the complexity of taking selfies.

In some embodiments, the another mode includes a tracking mode.

In the embodiment, in the tracking mode, a relative position between the UAV and the remote-control device is fixed.

In some embodiments, since the holder of the remote-control device finds it difficult to control the UAV in special environments (such as surfing, cycling, etc.) and wishes the UAV to capture images at a fixed relative position, in response to a third operation of the remote-control device, the selfie stick mode is switched to the tracking mode, so that the UAV tracks the holder of the remote-control device at a fixed relative position. By enabling the UAV to capture images of the holder of the remote-control device at a fixed relative position in the tracking mode, the holder of the remote-control device does not need to control the UAV and can perform stable shooting, thereby improving the selfie result. Moreover, by switching the selfie stick mode to the tracking mode with one operation, the way to switch between the selfie stick mode and the tracking mode is simple, thereby reducing the complexity of taking selfies.

In some embodiments, the another mode includes a first preset mode.

After the first preset mode ends, the method for controlling a UAV further includes:
switching the first preset mode to the selfie stick mode, and controlling the UAV to move to a position before the first preset mode starts.

In some embodiments, since the holder of the remote-control device does not need the UAV to capture images by circling in special environments and wishes to change the shooting mode of the UAV, in response to a third operation of the remote-control device, the selfie stick mode is switched to the first preset mode, so that the UAV moves in the first preset mode to capture images of the holder of the remote-control device. After the first preset mode ends, the holder of the remote-control device wishes the UAV to resume circling for shooting. The first preset mode is switched to the selfie stick mode, and the UAV is controlled to move to a position before the first preset mode starts to circle the holder of the remote-control device for shooting. By enabling the UAV to capture images of the holder of the remote-control device in a corresponding way in the first preset mode, the UAV can capture images of the holder of the remote-control device in different modes, thereby improving the selfie result. Moreover, by switching the selfie stick mode to the first preset mode with one operation, the way to switch between the selfie stick mode and the first preset mode is simple, thereby reducing the complexity of taking selfies.

In some embodiments, the another mode includes a first preset mode.

After the first preset mode ends, the method for controlling a UAV further includes:
switching the first preset mode to a second preset mode.

In some embodiments, since the holder of the remote-control device does not need the UAV to capture images by circling in special environments and wishes to change the mode of the UAV to perform shooting in a corresponding mode, in response to a third operation of the remote-control device, the selfie stick mode is switched to the first preset mode, so that the UAV moves in the first preset mode to capture images of the holder of the remote-control device. After the first preset mode ends, the holder of the remote-control device wishes the UAV to perform shooting in another mode, and the first preset mode is switched to the second preset mode. By enabling the UAV to capture images of the holder of the remote-control device in a corresponding way in the first preset mode and the second preset mode, the UAV can capture images of the holder of the remote-control device in different modes, thereby improving the selfie result. Moreover, by switching the selfie stick mode to the first preset mode with one operation, the way to switch between the selfie stick mode and the first preset mode is simple, thereby reducing the complexity of taking selfies.

In some embodiments, the first preset mode and the second preset mode are different modes. The first preset mode and the second preset mode may be a circling mode, a tiny planet mode, a waypoint mode, etc. The another mode may include one or more of the first preset mode and the second preset mode.

In some embodiments, the method for controlling a UAV further includes:
in the another mode, in response to a fourth operation of the remote-control device, switching back to the selfie stick mode from the another mode.

In some embodiments, since the holder of the remote-control device needs the UAV to simulate a real selfie stick to circle and capture images after leaving the special environment, in response to a fourth operation of the remote-control device, the another mode is switched back to the selfie stick mode, so that the UAV simulates a real selfie stick to circle the holder of the remote-control device for shooting. By switching the another mode to the selfie stick mode with one operation, the way to switch between the selfie stick mode and the another mode is simple, thereby reducing the complexity of taking selfies.

In some embodiments, the fourth operation includes one of a sliding operation of a fourth sliding key in the remote-control device, a rolling operation of a fourth rolling key in the remote-control device, a pressing operation of a fourth pressing key in the remote-control device, a fourth clicking operation of a screen in the remote-control device, a fourth touch operation of the remote-control device, a fourth swing operation of the remote-control device, or a fourth voice operation of the remote-control device.

In some embodiments, different shooting parameter settings correspond to different another modes.

In some embodiments, by making the shooting parameter settings corresponding to different modes different, the holder of the remote-control device can achieve different shooting effects through different shooting modes, thereby reducing the complexity of taking selfies.

In some embodiments, the shooting parameters may include one or more of a shooting angle, a shooting direction, acceleration/deceleration during video shooting, and a speed of UAV movement.

In some embodiments, in the selfie stick mode, the method for controlling a UAV further includes:
when there are people within a preset range of the holder of the remote-control device, increasing the distance between the UAV and the holder of the remote-control device, and reducing the circling speed of the UAV to simulate a real selfie stick.

In some embodiments, since in the selfie stick mode, the UAV simulates a real selfie stick to circle the holder of the remote-control device for shooting, if there are people near the holder of the remote-control device, the UAV may collide with people, posing a safety hazard.

When there are people within a preset range of the holder of the remote-control device, the distance between the UAV and the holder of the remote-control device is increased, and the circling speed of the UAV simulating a real selfie stick is reduced. By moving away from the holder of the remote-control device and reducing the circling speed, the possibility of danger caused by the UAV can be reduced, thereby improving the reliability of selfies.

In some embodiments, the method for controlling a UAV further includes:
in the selfie stick mode, determining a view-finding angle of view of the UAV; and
performing view-finding and shooting based on the view-finding angle of view.

In some embodiments, since the UAV's own camera may be multiple cameras facing different directions, or the mounted camera may be a panoramic camera, the image captured by the UAV may be a panoramic image. In the selfie stick mode, the view-finding angle of view of the UAV is determined, and view-finding and shooting are performed based on the view-finding angle of view. Since the UAV can perform shooting based on the angle of view, it can capture not only the holder of the remote-control device but also the environment in which the holder of the remote-control device is located, thereby improving the shooting effect.

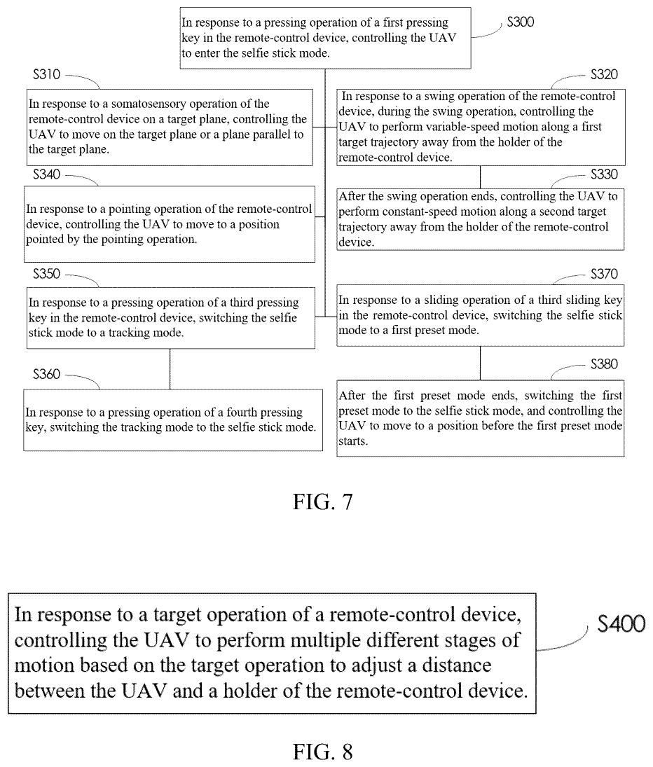

An embodiment of the present disclosure provides a method for controlling a UAV. As shown in FIG. 7, the method includes the following steps.

S300: In response to a pressing operation of a first pressing key in the remote-control device, controlling the UAV to enter the selfie stick mode.

S310: In response to a somatosensory operation of the remote-control device on a target plane, controlling the UAV to move on the target plane or a plane parallel to the target plane.

S320: In response to a swing operation of the remote-control device, during the swing operation, controlling the UAV to perform variable-speed motion along a first target trajectory away from the holder of the remote-control device.

S330: After the swing operation ends, controlling the UAV to perform constant-speed motion along a second target trajectory away from the holder of the remote-control device.

S340: In response to a pointing operation of the remote-control device, controlling the UAV to move to a position pointed by the pointing operation.

S350: In response to a pressing operation of a third pressing key in the remote-control device, switching the selfie stick mode to a tracking mode.

S360: In response to a pressing operation of a fourth pressing key, switching the tracking mode to the selfie stick mode.

S370: In response to a sliding operation of a third sliding key in the remote-control device, switching the selfie stick mode to a first preset mode.

S380: After the first preset mode ends, switching the first preset mode to the selfie stick mode, and controlling the UAV to move to a position before the first preset mode starts.

In some embodiments, in response to a pressing operation of a first pressing key in the remote-control device, the holder of the remote-control device needs to take selfies using the UAV, and the UAV is controlled to enter the selfie stick mode. In response to a somatosensory operation of the remote-control device on a target plane, the UAV is controlled to move to adjust the position of the UAV. In response to a swing operation of the remote-control device, the holder of the remote-control device needs to adjust the distance between the UAV and himself/herself. During the swing operation, the remote-control device is in motion and the movement speed changes, and the UAV is controlled to perform variable-speed motion along a first target trajectory away from the holder of the remote-control device. After the swing operation ends, the remote-control device is stationary, and the UAV is controlled to perform constant-speed motion along a second target trajectory away from the holder of the remote-control device. In response to a pointing operation of the remote-control device, the UAV is controlled to move to a position pointed by the pointing operation, so that the UAV can quickly move to the target position. In response to a pressing operation of a third pressing key in the remote-control device, the selfie stick mode is switched to a tracking mode, so that the UAV tracks the holder of the remote-control device. In response to a pressing operation of a fourth pressing key, the tracking mode is switched to the selfie stick mode, so that the UAV stops tracking the holder of the remote-control device. In response to a sliding operation of a third sliding key in the remote-control device, the selfie stick mode is switched to a first preset mode, so that the UAV captures images of the holder of the remote-control device in the first preset mode. After the first preset mode ends, the first preset mode is switched to the selfie stick mode, and the UAV is controlled to move to a position before the first preset mode starts to circle the holder of the remote-control device for shooting. Since, in the selfie stick mode, the position of the UAV can be adjusted by the somatosensory operation to take selfies from different positions, it avoids the difficulty for the holder of the remote-control device to control the UAV to capture a suitable image, thereby improving the selfie result and reducing the complexity of taking selfies.

An embodiment of the present disclosure provides a method for controlling a UAV. As shown in FIG. 8, the method includes:

S400: In response to a target operation of a remote-control device, controlling the UAV to perform multiple different stages of motion based on the target operation to adjust a distance between the UAV and a holder of the remote-control device.

In some embodiments, since the holder of the remote-control device hopes to see a visually engaging movement of the UAV when adjusting the distance between the UAV and the holder of the remote-control device, in response to a target operation of the remote-control device, the UAV is controlled to perform multiple different stages of motion based on the target operation to achieve an enhanced visual effect. By controlling the movement of the UAV via the target operation, only one operation is needed for the UAV to move in a stylish way, thereby improving the diversity of UAV movement and reducing the complexity of UAV control.

In some embodiments, when the target operation is a swing operation of the remote-control device, the controlling the UAV to perform multiple different stages of motion based on the target operation in step S400 may be determined as follows:
during the swing operation, control the UAV to perform variable-speed motion along a first target trajectory away from the holder of the remote-control device; and
after the swing operation ends, control the UAV to perform constant-speed motion along a second target trajectory away from the holder of the remote-control device.

In some embodiments, during the swing operation, the remote-control device is in motion and the movement speed changes, and the UAV is controlled to perform variable-speed motion along a first target trajectory away from the holder of the remote-control device. After the swing operation ends, the remote-control device is stationary, and the UAV is controlled to perform constant-speed motion along a second target trajectory away from the holder of the remote-control device. By controlling the UAV to move at different trajectories and speeds via the swing operation, the UAV can move in a stylish way, thereby improving the diversity of UAV movement and reducing the complexity of UAV control.

In some embodiments, a speed of the variable-speed motion is positively correlated with a force of the swing operation.

In some embodiments, by making the speed of the variable-speed motion positively correlated with the force of the swing operation, the speed of the variable-speed motion of the UAV can be adjusted by the force of the swing operation, and the adjustment method conforms to the habits of the holder of the remote-control device, thereby reducing the complexity of UAV control.

In some embodiments, under the swing operation, the relationship between the speed of the variable-speed motion and time can be preset. A proportional coefficient is set in the relationship, and the proportional coefficient is positively correlated with the force of the swing operation, so that the speed of the variable-speed motion increases as the force of the swing operation increases. The speed of the variable-speed motion may gradually increase or decrease with time. Alternatively, the speed of the variable-speed motion may be unrelated to time and only positively correlated with the force of the swing operation. For example, the speed of the variable-speed motion may be a preset speed multiplied by the proportional coefficient, and the proportional coefficient is positively correlated with the force of the swing operation. It should be understood that the above is only an example, and the method for determining the speed of the variable-speed motion is not limited in the present disclosure.

It should be understood that the speed of the variable-speed motion may also be negatively correlated with or unrelated to the force of the swing operation. That is, the speed of the variable-speed motion may be a preset variable speed, which is not limited herein.

In some embodiments, the first target trajectory is determined based on the force and/or arc of the swing operation.

In some embodiments, by determining the first target trajectory based on the force and/or arc of the swing operation, the holder of the remote-control device can make the UAV perform variable-speed motion along different trajectories under different swing operations to achieve an enhanced visual effect, thereby improving the diversity of UAV movement.

In some embodiments, the first target trajectory may be a preset trajectory under different forces and/or arcs of the swing operation. For example, when the force and/or arc of the swing operation is within a first preset range, the first target trajectory is a linear trajectory. When the force and/or arc of the swing operation is within a second preset range, the first target trajectory is an arc trajectory. When the force and/or arc of the swing operation is within a third preset range, the first target trajectory is a spiral trajectory. Alternatively, the first target trajectory may be a curved trajectory, and the radius of the curved trajectory is positively correlated with the force and/or arc of the swing operation. Alternatively, the first target trajectory may also be a spiral trajectory, and the radius of the spiral trajectory is positively correlated with the force and/or arc of the swing operation. The arc of the swing operation may be the arc of the swing of the remote-control device or the amplitude of the swing of the remote-control device. It should be understood that the above is only an example, and the method for determining the first target trajectory is not limited to the embodiments described in the present disclosure.

It should be understood that the first target trajectory may also be unrelated to the force and arc of the swing operation. That is, the first target trajectory may be a preset trajectory, such as a linear trajectory, an arc trajectory, a spiral trajectory, etc., which is not limited herein.

In some embodiments, a speed of the constant-speed motion is determined based on a speed of the variable-speed motion and/or the first target trajectory.

In some embodiments, by making the speed of the constant-speed motion determined based on the speed of the variable-speed motion and/or the first target trajectory, the movement speeds of the UAV in the two different stages are correlated to achieve an enhanced visual effect, and the two stages of movement can be smoothly connected, thereby improving the diversity of UAV movement.

In some embodiments, the speed of the constant-speed motion may be the speed at the end of the variable-speed motion, the average speed of the variable-speed motion, the initial speed of the variable-speed motion, etc., or may be the ratio of the distance of the first target trajectory to a preset value, or may be the average value of the speed at the end of the variable-speed motion and the ratio of the distance of the first target trajectory to a preset value, etc. It should be understood that the above is only an example, and the method for determining the speed of the constant-speed motion is not limited in the present disclosure.

It should be understood that the speed of the constant-speed motion may also be unrelated to the speed of the variable-speed motion and the first target trajectory. That is, the speed of the constant-speed motion may be a preset fixed speed, which is not limited herein.

In some embodiments, the second target trajectory is determined based on the first target trajectory.

In some embodiments, by making the second target trajectory determined based on the first target trajectory, the movement trajectories of the UAV in the two different stages are correlated to achieve an enhanced visual effect, and the two stages of movement can be smoothly connected, thereby improving the diversity of UAV movement.

In some embodiments, the second target trajectory may be the same as or different from the first target trajectory. For example, when the first target trajectory is a curved trajectory, the second target trajectory may be a linear trajectory or a spiral trajectory. When the first target trajectory is a linear trajectory, the second target trajectory may be a curved trajectory or a spiral trajectory. When the first target trajectory is a spiral trajectory, the second target trajectory may be a linear trajectory or a curved trajectory. Alternatively, the second target trajectory may be a linear trajectory along the direction at the end of the first target trajectory. It should be understood that the above is only an example, and the method for determining the second target trajectory is not limited in the present disclosure.

It should be understood that the second target trajectory may also be unrelated to the first target trajectory. That is, the second target trajectory may be a preset trajectory, such as a linear trajectory, an arc trajectory, a spiral trajectory, etc., which is not limited herein.

In some embodiments, when the target operation is a swing operation of the remote control device, the controlling the UAV to perform multiple different stages of motion based on the target operation in step S400 may also be determined as follows:
during the swing operation, controlling the UAV to perform variable-speed motion along a curved trajectory, a radius of the curved trajectory gradually increasing with a duration of the swing operation, and a central angle of the curved trajectory being a central angle of the swing operation; and after the swing operation ends, controlling the UAV to perform constant-speed motion along a linear trajectory away from the holder of the remote-control device.

In some embodiments, during the swing operation, the remote-control device is in motion and the movement speed changes, and the UAV is controlled to perform variable-speed motion along a curved trajectory whose radius gradually increases with the duration of the swing operation. After the swing operation ends, the remote-control device is stationary, and the UAV is controlled to perform constant-speed motion along a linear trajectory away from the holder of the remote-control device so that the UAV moves based on inertia. By controlling the UAV to move at different trajectories and speeds via the swing operation, the UAV can move in a stylish way, thereby improving the diversity of UAV movement and reducing the complexity of UAV control.

It should be understood that, during the swing operation, the UAV may also perform constant-speed motion. After the swing operation ends, the UAV may also perform variable-speed motion, which is not limited herein.

In some embodiments, the speed of the variable-speed motion may be positively correlated, negatively correlated, or unrelated to the force of the swing operation. The speed of the constant-speed motion may be determined based on the speed of the variable-speed motion or may be a preset speed.

In some embodiments, the method for controlling a UAV further includes:
in response to a somatosensory operation of the remote-control device, controlling the UAV to move from an initial position to a target position, the initial position being a position of the UAV before the somatosensory operation, and the target position being a position of the UAV pointed to when the somatosensory operation stops.

In the embodiment, a trajectory of moving from the initial position to the target position is a curved trajectory, the curved trajectory is a part of a spherical trajectory, a sphere center of the spherical trajectory is a position of the holder of the remote-control device, and a radius of the spherical trajectory is a distance between the UAV and the holder of the remote-control device.

In some embodiments, since the holder of the remote-control device needs to move the UAV by performing a somatosensory operation on the remote-control device to change the position of the UAV, in response to the somatosensory operation of the remote-control device, the UAV is controlled to move from the initial position before the somatosensory operation to the target position pointed to when the somatosensory operation stops. Since the trajectory from the initial position to the target position is a curved trajectory, and the curved trajectory is a part of a spherical trajectory, the UAV can circle around the holder of the remote-control device. By changing the position of the UAV through the somatosensory operation, only the somatosensory operation is needed to control the movement of the UAV, thereby reducing the complexity of UAV control.

In some embodiments, the controlling the UAV to move from the initial position to the target position in response to the somatosensory operation of the remote-control device as described above may be determined as follows:
in response to the somatosensory operation of the remote-control device, controlling the UAV to follow the somatosensory operation of the remote-control device along the curved trajectory from the initial position to the target position, where a relative rotation angle of the UAV and the remote-control device remains unchanged.

In some embodiments, since the holder of the remote-control device needs to move the UAV by performing a somatosensory operation on the remote-control device to change the position of the UAV, in response to the somatosensory operation of the remote-control device, the UAV is controlled to follow the somatosensory operation of the remote-control device along the curved trajectory from the initial position to the target position, and the position of the UAV is adjusted while the relative rotation angle remains unchanged. Since the somatosensory operation lasts for a certain period of time, the UAV follows the remote-control device in real time during the operation of the remote-control device to keep the relative rotation angle unchanged. By moving the UAV with the relative rotation angle unchanged through the somatosensory operation, the angle of movement of the UAV along the spherical trajectory can be controlled by the rotation angle of the remote-control device, and the movement angle of the UAV can be consistent with the rotation angle of the remote-control device, thereby reducing the complexity of UAV control.

In some embodiments, the controlling the UAV to move from the initial position to the target position in response to the somatosensory operation of the remote-control device as described above may also be determined as follows:
when the somatosensory operation is a rotation operation of the remote-control device on a target plane, controlling the UAV to move along the curved trajectory on the target plane or a plane parallel to the target plane.

In some embodiments, since only the remote-control device needs to be rotated on the target plane, the UAV can be moved on the corresponding plane to change the position of the UAV, thereby reducing the complexity of UAV control.

In some embodiments, a central angle corresponding to the curved trajectory of the UAV moving on the plane is positively correlated with an angle of the remote-control device rotating on the target plane.

In some embodiments, by making the central angle corresponding to the curved trajectory of the UAV moving on the plane positively correlated with the angle of the remote-control device rotating on the target plane, the holder of the remote-control device can move the UAV to a farther position by increasing the rotation amount to suit the holder's habits, thereby reducing the complexity of UAV control.

In some embodiments, a distance of the UAV moving on the plane is positively correlated with the angle of the remote-control device rotating on the target plane.

In some embodiments, by making the distance of the UAV moving on the plane positively correlated with the angle of the remote-control device rotating on the target plane, the holder of the remote-control device can move the UAV to a farther position by increasing the rotation amount to suit the holder's habits, thereby reducing the complexity of UAV control.

In some embodiments, a speed of the UAV moving on the plane is positively correlated with a speed of the remote-control device rotating on the target plane.

In some embodiments, by making the speed of the UAV moving on the plane positively correlated with the speed of the remote-control device rotating on the target plane, the holder of the remote-control device can make the UAV move faster by increasing the rotation speed to suit the holder's habits, thereby reducing the complexity of UAV control.

In some embodiments, the speed of the UAV moving on the plane is a preset speed.

In some embodiments, by making the speed of the UAV moving on the plane a preset speed, it is possible to avoid the UAV moving too fast or too slow, thereby reducing the complexity of UAV control.

In some embodiments, during the rotation of the remote-control device, the speed of rotation of the remote-control device can be detected, and whether the somatosensory operation is valid can be determined according to the speed of rotation of the remote-control device to avoid the UAV malfunctioning due to misoperation by the holder of the remote-control device. For example, when the speed of rotation of the remote-control device is 30°/s, the somatosensory operation is determined to be valid. When the speed of rotation of the remote-control device is 180°/s, the somatosensory operation is determined to be invalid. When the somatosensory operation is invalid, the UAV is not controlled.

In some embodiments, the controlling the UAV to move from the initial position to the target position in response to the somatosensory operation of the remote-control device as described above may further be determined as follows:
determine real-time relative pose information corresponding to the remote-control device during the somatosensory operation;
determine a real-time control quantity corresponding to the UAV based on the real-time relative pose information; and
control the UAV to move along the curved trajectory to a position corresponding to the real-time control quantity based on the real-time control quantity.

In some embodiments, the real-time relative pose information corresponding to the remote-control device during the somatosensory operation is determined to determine the extent to which the holder of the remote-control device needs to control the movement of the UAV. The real-time control quantity corresponding to the UAV is determined based on the real-time relative pose information, so as to convert the somatosensory operation into a real-time control quantity. The UAV is controlled to move along the curved trajectory to a position corresponding to the real-time control quantity based on the real-time control quantity, so that the UAV moves under the action of the real-time control quantity. By controlling the movement of the UAV in real time, the UAV does not need to change its inherent control method and can be applied to various types of UAVs, and it is possible to avoid delays in the movement of the UAV, thereby improving the reliability of UAV control.

In some embodiments, the controlling the UAV to move from the initial position to the target position in response to the somatosensory operation of the remote-control device as described above may further be determined as follows:
determine real-time relative pose information corresponding to the remote-control device during the somatosensory operation; and
control the UAV to move along the curved trajectory to a position corresponding to the real-time relative pose information based on the real-time relative pose information.

In some embodiments, the controlling the UAV to move from the initial position to the target position in response to the somatosensory operation of the remote-control device as described above may further be determined as follows:
determine real-time relative pose information corresponding to the remote-control device during the somatosensory operation;
determine a control instruction corresponding to the UAV based on the real-time relative pose information; and
control the UAV to move along the curved trajectory to a position corresponding to the control instruction based on the control instruction.

In some embodiments, the method for controlling a UAV further includes:
in response to a movement operation of the remote-control device, controlling the UAV to move following the movement operation of the remote-control device, and maintaining a distance between the UAV and the remote-control device unchanged during the movement.

In some embodiments, by making the UAV move following the remote-control device via a movement operation and maintaining the distance between the UAV and the remote-control device unchanged, the UAV can adjust the position without changing the distance, thereby reducing the complexity of UAV control.

In some embodiments, the method for controlling a UAV further includes:
in response to a composite operation of the remote-control device, the composite operation including a somatosensory operation and a movement operation, controlling the UAV to adjust the position and the distance simultaneously based on the composite operation, and maintaining a relative rotation angle of the UAV and the remote-control device unchanged during the adjustment, while maintaining the distance between the UAV and the remote-control device unchanged.

In some embodiments, since the holder of the remote-control device needs to move the UAV by performing a somatosensory operation on the remote-control device to change the position of the UAV on the spherical trajectory, and needs to move the UAV by performing a movement operation on the remote-control device to change the position of the spherical trajectory, in response to the composite operation of the remote-control device, the UAV is controlled to adjust the position and the distance simultaneously based on the composite operation, so as to adjust the position of the UAV while maintaining the relative rotation angle and the distance unchanged. By moving the UAV with the relative rotation angle and the distance unchanged through the composite operation, the movement of the UAV can be controlled by the rotation angle and the movement distance of the remote-control device, thereby reducing the complexity of UAV control.

In some embodiments, the method for controlling a UAV further includes:
in response to a pointing operation of the remote-control device, controlling the UAV to move to a position pointed by the pointing operation.

In some embodiments, since the holder of the remote-control device may wish the UAV to move to a target position, if this is achieved by adjusting the distance between the UAV and the holder of the remote-control device and/or the attitude of the UAV, a large number of operations are required and it is difficult to accurately locate. By controlling the UAV to move to a position pointed by the pointing operation, the UAV can quickly reach the target position, thereby reducing the complexity of UAV control.

In an exemplary embodiment, a remote-control device is provided, including a processor and a memory, the memory storing a computer program, and when the computer program instructions are executed by the processor, the processor is configured to:
in response to a first operation of the remote-control device, control a UAV to enter the selfie stick mode.

In the selfie stick mode, in response to a somatosensory operation of the remote-control device, control the UAV to adjust a position based on the somatosensory operation, the position referring to a position of the UAV relative to a holder of the remote-control device.

In an exemplary embodiment, the processor is configured to:
in response to a somatosensory operation of the remote-control device, control the UAV to move from an initial position to a target position, the initial position being a position of the UAV before the somatosensory operation, and the target position being a position of the UAV pointed to when the somatosensory operation stops.

In the embodiment, a trajectory of moving from the initial position to the target position is a curved trajectory, the curved trajectory is a part of a spherical trajectory, a sphere center of the spherical trajectory is a position of the holder of the remote-control device, and a radius of the spherical trajectory is a distance between the UAV and the holder of the remote-control device.

In an exemplary embodiment, the processor is configured to:
in response to the somatosensory operation of the remote-control device, control the UAV to follow the somatosensory operation of the remote-control device along the curved trajectory from the initial position to the target position, where a relative rotation angle of the UAV and the remote-control device remains unchanged.

In an exemplary embodiment, the processor is configured to:
when the somatosensory operation is a rotation operation of the remote-control device on a target plane, control the UAV to move along the curved trajectory on the target plane or a plane parallel to the target plane.

In an exemplary embodiment, a central angle corresponding to the curved trajectory of the UAV moving on the plane is positively correlated with an angle of the remote-control device rotating on the target plane; or a distance of the UAV moving on the plane is positively correlated with the angle of the remote-control device rotating on the target plane.

In an exemplary embodiment, a speed of the UAV moving on the plane is positively correlated with a speed of the remote-control device rotating on the target plane; or the speed of the UAV moving on the plane is a preset speed.

In an exemplary embodiment, the processor is configured to:
in the selfie stick mode, in response to a movement operation of the remote-control device, control the UAV to move following the movement operation of the remote-control device, and maintain a distance between the UAV and the remote-control device unchanged during the movement.

In an exemplary embodiment, the processor is configured to:

in the selfie stick mode, in response to a composite operation of the remote-control device, the composite operation including a somatosensory operation and a movement operation, control the UAV to adjust the position and the distance simultaneously based on the composite operation, and maintain a relative rotation angle of the UAV and the remote-control device unchanged during the adjustment, while maintaining the distance between the UAV and the remote-control device unchanged.

In an exemplary embodiment, the processor is configured to:
determine real-time relative pose information corresponding to the remote-control device during the somatosensory operation;
determine a real-time control quantity corresponding to the UAV based on the real-time relative pose information; and
control the UAV to move along the curved trajectory to a position corresponding to the real-time control quantity based on the real-time control quantity.

In an exemplary embodiment, the processor is configured to:
determine a real-time angle mapped to a corresponding axis for the remote-control device during the somatosensory operation, the corresponding axis including at least one of a pitch axis, a yaw axis, or a roll axis, and use the real-time angle mapped to the corresponding axis as the real-time relative pose information.

In an exemplary embodiment, the processor is configured to:
in response to a pointing operation of the remote-control device, control the UAV to move to a position pointed by the pointing operation.

In an exemplary embodiment, the first operation includes one of a sliding operation of a first sliding key in the remote-control device, a rolling operation of a first rolling key in the remote-control device, a pressing operation of a first pressing key in the remote-control device, a first clicking operation of a screen in the remote-control device, a first touch operation of the remote-control device, a first swing operation of the remote-control device, or a first voice operation of the remote-control device.

In an exemplary embodiment, the processor is configured to:
in the selfie stick mode, in response to a second operation of the remote-control device, adjust a distance between the UAV and the holder of the remote-control device.

In an exemplary embodiment, the processor is configured to:
when the second operation is a swing operation of the remote-control device, control the UAV to perform multiple different stages of motion based on the swing operation to adjust the distance between the UAV and the holder of the remote-control device.

In an exemplary embodiment, the processor is configured to:
during the swing operation, control the UAV to perform variable-speed motion along a first target trajectory away from the holder of the remote-control device; and
after the swing operation ends, control the UAV to perform constant-speed motion along a second target trajectory away from the holder of the remote-control device.

In an exemplary embodiment, a speed of the variable-speed motion is positively correlated with a force of the swing operation; and/or the first target trajectory is determined based on the force and/or arc of the swing operation; and/or a speed of the constant-speed motion is determined based on a speed of the variable-speed motion and/or the first target trajectory; and/or the second target trajectory is determined based on the first target trajectory.

In an exemplary embodiment, the processor is configured to:
during the swing operation, control the UAV to perform variable-speed motion along a curved trajectory, a radius of the curved trajectory gradually increasing with a duration of the swing operation, and a central angle of the curved trajectory being a central angle of the swing operation; and
after the swing operation ends, control the UAV to perform constant-speed motion along a linear trajectory away from the holder of the remote-control device.

In an exemplary embodiment, the processor is configured to:
in response to the second operation, control the UAV to move in a direction of a connecting line between the UAV and the holder of the remote-control device to adjust the distance between the UAV and the holder of the remote-control device.

In an exemplary embodiment, a speed of the UAV is positively correlated with a movement distance; or the speed of the UAV is a preset speed.

In an exemplary embodiment, the second operation includes one of a sliding operation of a second sliding key in the remote-control device, a rolling operation of a second rolling key in the remote-control device, a pressing operation of a second pressing key in the remote-control device, a second clicking operation of a screen in the remote-control device, a second touch operation of the remote-control device, a second swing operation of the remote-control device, or a second voice operation of the remote-control device.

In an exemplary embodiment, the processor is configured to:
in the selfie stick mode, in response to a third operation of the remote-control device, switch the selfie stick mode to another mode based on the third operation, the another mode being a mode other than the selfie stick mode.

In an exemplary embodiment, the third operation includes one of a sliding operation of a third sliding key in the remote-control device, a rolling operation of a third rolling key in the remote-control device, a pressing operation of a third pressing key in the remote-control device, a third clicking operation of a screen in the remote-control device, a third touch operation of the remote-control device, a third swing operation of the remote-control device, or a third voice operation of the remote-control device.

In an exemplary embodiment, the processor is configured to:
in the another mode, in response to a fourth operation of the remote-control device, switch back to the selfie stick mode from the another mode.

In an exemplary embodiment, different shooting parameter settings correspond to different another modes.

In an exemplary embodiment, the processor is configured to:
in the selfie stick mode, determine a view-finding angle of view of the UAV; and
perform view-finding and shooting based on the view-finding angle of view.

In an exemplary embodiment, a remote-control device is provided, including a processor and a memory, the memory storing a computer program, and when the computer program instructions are executed by the processor, the processor is configured to:
in response to a target operation of a remote-control device, control the UAV to perform multiple different stages of motion based on the target operation to adjust a distance between the UAV and a holder of the remote-control device.

In an exemplary embodiment, in the case where the target operation is a swing operation of the remote-control device, the processor is configured to:
during the swing operation, control the UAV to perform variable-speed motion along a first target trajectory away from the holder of the remote-control device; and
after the swing operation ends, control the UAV to perform constant-speed motion along a second target trajectory away from the holder of the remote-control device.

In an exemplary embodiment, a speed of the variable-speed motion is positively correlated with a force of the swing operation; and/or the first target trajectory is determined based on the force and/or arc of the swing operation; and/or a speed of the constant-speed motion is determined based on a speed of the variable-speed motion and/or the first target trajectory; and/or the second target trajectory is determined based on the first target trajectory.

In an exemplary embodiment, in the case where the target operation is a swing operation of the remote-control device, the processor is configured to:
during the swing operation, control the UAV to perform variable-speed motion along a curved trajectory, a radius of the curved trajectory gradually increasing with a duration of the swing operation, and a central angle of the curved trajectory being a central angle of the swing operation; and
after the swing operation ends, control the UAV to perform constant-speed motion along a linear trajectory away from the holder of the remote-control device.

In an exemplary embodiment, the processor is configured to:
in response to a somatosensory operation of the remote-control device, control the UAV to move from an initial position to a target position, the initial position being a position of the UAV before the somatosensory operation, and the target position being a position of the UAV pointed to when the somatosensory operation stops.

In the embodiment, a trajectory of moving from the initial position to the target position is a curved trajectory, the curved trajectory is a part of a spherical trajectory, a sphere center of the spherical trajectory is a position of the holder of the remote-control device, and a radius of the spherical trajectory is a distance between the UAV and the holder of the remote-control device.

In an exemplary embodiment, the processor is configured to:
control the UAV to follow the somatosensory operation of the remote-control device along the curved trajectory from the initial position to the target position in response to the somatosensory operation of the remote-control device, where a relative rotation angle of the UAV and the remote-control device remains unchanged.

In an exemplary embodiment, the processor is configured to:
when the somatosensory operation is a rotation operation of the remote-control device on a target plane, control the UAV to move along the curved trajectory on the target plane or a plane parallel to the target plane.

In an exemplary embodiment, a central angle corresponding to the curved trajectory of the UAV moving on the plane is positively correlated with an angle of the remote-control device rotating on the target plane; or a distance of the UAV moving on the plane is positively correlated with the angle of the remote-control device rotating on the target plane.

In an exemplary embodiment, a speed of the UAV moving on the plane is positively correlated with a speed of the remote-control device rotating on the target plane; or the speed of the UAV moving on the plane is a preset speed.

In an exemplary embodiment, the processor is configured to:
in response to a movement operation of the remote-control device, control the UAV to move following the movement operation of the remote-control device, and maintain a distance between the UAV and the remote-control device unchanged during the movement.

In an exemplary embodiment, the processor is configured to:
in response to a pointing operation of the remote-control device, control the UAV to move to a position pointed by the pointing operation.

In an exemplary embodiment, a UAV control system is provided, including a remote-control device and a UAV.

The remote-control device is configured to send a first control signal to the UAV in response to a first operation of the remote-control device. In the selfie stick mode, the remote-control device is configured to send a second control signal to the UAV in response to a somatosensory operation of the remote-control device.

The UAV may be configured to receive the first control signal and the second control signal. The UAV may be further configured to enter the selfie stick mode based on the received first control signal. In the selfie stick mode, the UAV is configured to adjust a position based on the received second control signal, the position referring to a position of the UAV relative to a holder of the remote-control device.

In an exemplary embodiment, the UAV is configured to move from an initial position to a target position based on the received second control signal, the initial position being a position of the UAV before the somatosensory operation, the target position being a position of the UAV pointed to when the somatosensory operation stops.

In the embodiment, a trajectory of moving from the initial position to the target position is a curved trajectory, the curved trajectory is a part of a spherical trajectory, a sphere center of the spherical trajectory is a position of the holder of the remote-control device, and a radius of the spherical trajectory is a distance between the UAV and the holder of the remote-control device.

In an exemplary embodiment, the UAV is configured to follow the somatosensory operation of the remote-control device along the curved trajectory from the initial position to the target position based on the received second control signal, where a relative rotation angle of the UAV and the remote-control device remains unchanged.

In an exemplary embodiment, the UAV is configured to, when the somatosensory operation is a rotation operation of the remote-control device on a target plane, move along the curved trajectory on the target plane or a plane parallel to the target plane based on the received second control signal.

In an exemplary embodiment, a central angle corresponding to the curved trajectory of the UAV moving on the plane is positively correlated with an angle of the remote-control device rotating on the target plane; or a distance of the UAV moving on the plane is positively correlated with the angle of the remote-control device rotating on the target plane.

In an exemplary embodiment, a speed of the UAV moving on the plane is positively correlated with a speed of the remote-control device rotating on the target plane; or the speed of the UAV moving on the plane is a preset speed.

In an exemplary embodiment, the remote-control device is configured to, in the selfie stick mode, send a third control signal to the UAV in response to a movement operation of the remote-control device.

The UAV is configured to move following the movement operation of the remote-control device based on the received third control signal, and maintain a distance between the UAV and the remote-control device unchanged during the movement.

In an exemplary embodiment, the remote-control device is configured to, in the selfie stick mode, send a fourth control signal to the UAV in response to a composite operation of the remote-control device, the composite operation including a somatosensory operation and a movement operation.

The UAV is configured to adjust the position and the distance simultaneously based on the received fourth control signal, and maintain a relative rotation angle of the UAV and the remote-control device unchanged during the adjustment, while maintaining the distance between the UAV and the remote-control device unchanged.

In an exemplary embodiment, the remote-control device is configured to: determine real-time relative pose information corresponding to the remote-control device during the somatosensory operation;
determine a real-time control quantity corresponding to the UAV based on the real-time relative pose information; and
send the first control signal to the UAV based on the real-time control quantity.

The UAV is configured to move along the curved trajectory to a position corresponding to the real-time control quantity based on the received first control signal.

In an exemplary embodiment, the remote-control device is configured to determine a real-time angle mapped to a corresponding axis for the remote-control device during the somatosensory operation, the corresponding axis including at least one of a pitch axis, a yaw axis, or a roll axis, and use the real-time angle mapped to the corresponding axis as the real-time relative pose information.

In an exemplary embodiment, the remote-control device is configured to, in response to a pointing operation of the remote-control device, send a fifth control signal to the UAV.

The UAV is configured to move to a position pointed by the pointing operation based on the received fifth control signal.

In an exemplary embodiment, the first operation includes one of a sliding operation of a first sliding key in the remote-control device, a rolling operation of a first rolling key in the remote-control device, a pressing operation of a first pressing key in the remote-control device, a first clicking operation of a screen in the remote-control device, a first touch operation of the remote-control device, a first swing operation of the remote-control device, or a first voice operation of the remote-control device.

In an exemplary embodiment, the remote-control device is configured to, in the selfie stick mode, send a sixth control signal to the UAV in response to a second operation of the remote-control device.

The UAV is configured to adjust a distance between the UAV and the holder of the remote-control device based on the received sixth control signal.

In an exemplary embodiment, the UAV is configured to, when the second operation is a swing operation of the remote-control device, perform multiple different stages of motion based on the received sixth control signal and the swing operation to adjust the distance between the UAV and the holder of the remote-control device.

In an exemplary embodiment, the UAV is configured to, during the swing operation, perform variable-speed motion along a first target trajectory away from the holder of the remote-control device.

After the swing operation ends, perform constant-speed motion along a second target trajectory away from the holder of the remote-control device.

In an exemplary embodiment, a speed of the variable-speed motion is positively correlated with a force of the swing operation; and/or the first target trajectory is determined based on the force and/or arc of the swing operation; and/or a speed of the constant-speed motion is determined based on a speed of the variable-speed motion and/or the first target trajectory; and/or the second target trajectory is determined based on the first target trajectory.

In an exemplary embodiment, the UAV is configured to: during the swing operation, perform variable-speed motion along a curved trajectory, a radius of the curved trajectory gradually increasing with a duration of the swing operation, and a central angle of the curved trajectory being a central angle of the swing operation; and
after the swing operation ends, perform constant-speed motion along a linear trajectory away from the holder of the remote-control device.

In an exemplary embodiment, the UAV is configured to, based on the received sixth control signal, move in a direction of a connecting line between the UAV and the holder of the remote-control device to adjust the distance between the UAV and the holder of the remote-control device.

In an exemplary embodiment, a speed of the UAV is positively correlated with a movement distance; or the speed of the UAV is a preset speed.

In an exemplary embodiment, the second operation includes one of a sliding operation of a second sliding key in the remote-control device, a rolling operation of a second rolling key in the remote-control device, a pressing operation of a second pressing key in the remote-control device, a second clicking operation of a screen in the remote-control device, a second touch operation of the remote-control device, a second swing operation of the remote-control device, or a second voice operation of the remote-control device.

In an exemplary embodiment, the remote-control device is configured to, in the selfie stick mode, send a seventh control signal to the UAV in response to a third operation of the remote-control device.

The UAV is configured to switch the selfie stick mode to another mode based on the received seventh control signal, the another mode being a mode other than the selfie stick mode.

In an exemplary embodiment, the third operation includes one of a sliding operation of a third sliding key in the remote-control device, a rolling operation of a third rolling key in the remote-control device, a pressing operation of a third pressing key in the remote-control device, a third clicking operation of a screen in the remote-control device, a third touch operation of the remote-control device, a third swing operation of the remote-control device, or a third voice operation of the remote-control device.

In an exemplary embodiment, the remote-control device is configured to, in the another mode, send an eighth control signal to the UAV in response to a fourth operation of the remote-control device.

The UAV is configured to switch back to the selfie stick mode from the another mode based on the received eighth control signal.

In an exemplary embodiment, different shooting parameter settings correspond to different another modes.

In an exemplary embodiment, the UAV is configured to: in the selfie stick mode, determine a view-finding angle of view; and perform view-finding and shooting based on the view-finding angle of view.

In an exemplary embodiment, a UAV control system is provided, including a remote-control device and a UAV.

The remote-control device is configured to send a first target signal to the UAV in response to a target operation of the remote-control device by a holder of the remote-control device.

The UAV is configured to perform multiple different stages of motion based on the received first target signal to adjust a distance between the UAV and the holder of the remote-control device.

In an exemplary embodiment, the UAV is configured to: when the target operation is a swing operation of the remote-control device, perform variable-speed motion along a first target trajectory away from the holder of the remote-control device during the swing operation based on the received first target signal; and perform constant-speed motion along a second target trajectory away from the holder of the remote-control device after the swing operation ends.

In an exemplary embodiment, a speed of the variable-speed motion is positively correlated with a force of the swing operation; and/or the first target trajectory is determined based on the force and/or arc of the swing operation; and/or a speed of the constant-speed motion is determined based on a speed of the variable-speed motion and/or the first target trajectory; and/or the second target trajectory is determined based on the first target trajectory.

In an exemplary embodiment, the UAV is configured to: when the target operation is a swing operation of the remote-control device, perform variable-speed motion along a curved trajectory during the swing operation based on the received first target signal, a radius of the curved trajectory gradually increasing with a duration of the swing operation, and a central angle of the curved trajectory being a central angle of the swing operation; and perform constant-speed motion along a linear trajectory away from the holder of the remote-control device after the swing operation ends.

In an exemplary embodiment, the remote-control device is configured to, in response to a somatosensory operation of the remote-control device, send a second target signal to the UAV.

The UAV is configured to move from an initial position to a target position based on the received second target signal, the initial position being a position of the UAV before the somatosensory operation, the target position being a position of the UAV pointed to when the somatosensory operation stops.

In the embodiment, a trajectory of moving from the initial position to the target position is a curved trajectory, the curved trajectory is a part of a spherical trajectory, a sphere center of the spherical trajectory is a position of the holder of the remote-control device, and a radius of the spherical trajectory is a distance between the UAV and the holder of the remote-control device.

In an exemplary embodiment, the UAV is configured to follow the somatosensory operation of the remote-control device along the curved trajectory from the initial position to the target position based on the received second target signal, where a relative rotation angle of the UAV and the remote-control device remains unchanged.

In an exemplary embodiment, the UAV is configured to, when the somatosensory operation is a rotation operation of the remote-control device on a target plane, move along the curved trajectory on the target plane or a plane parallel to the target plane based on the received second target signal.

In an exemplary embodiment, a central angle corresponding to the curved trajectory of the UAV moving on the plane is positively correlated with an angle of the remote-control device rotating on the target plane; or a distance of the UAV moving on the plane is positively correlated with the angle of the remote-control device rotating on the target plane.

In an exemplary embodiment, a speed of the UAV moving on the plane is positively correlated with a speed of the remote-control device rotating on the target plane; or the speed of the UAV moving on the plane is a preset speed.

In an exemplary embodiment, the remote-control device is configured to, in response to a movement operation of the remote-control device, send a third target signal to the UAV.

The UAV is configured to move following the movement operation of the remote-control device based on the received third target signal, and maintain a distance between the UAV and the remote-control device unchanged during the movement.

In an exemplary embodiment, the remote-control device is configured to, in response to a pointing operation of the remote-control device, send a fourth target signal to the UAV.

The UAV is configured to move to a position pointed by the pointing operation based on the received fourth target signal.

In an exemplary embodiment, a computer-readable storage medium is provided, storing a computer program, where when the computer program is executed by a processor, the steps of any of the above methods are implemented. The computer-readable storage medium may be a read-only memory (ROM), random access memory (RAM), Compact Disc Read-Only Memory (CD-ROM), magnetic tape, floppy disk, optical data storage device, etc.

In an exemplary embodiment, a computer program product is provided, including a computer program, where when the computer program is executed by a processor, the steps of any of the above methods are implemented.

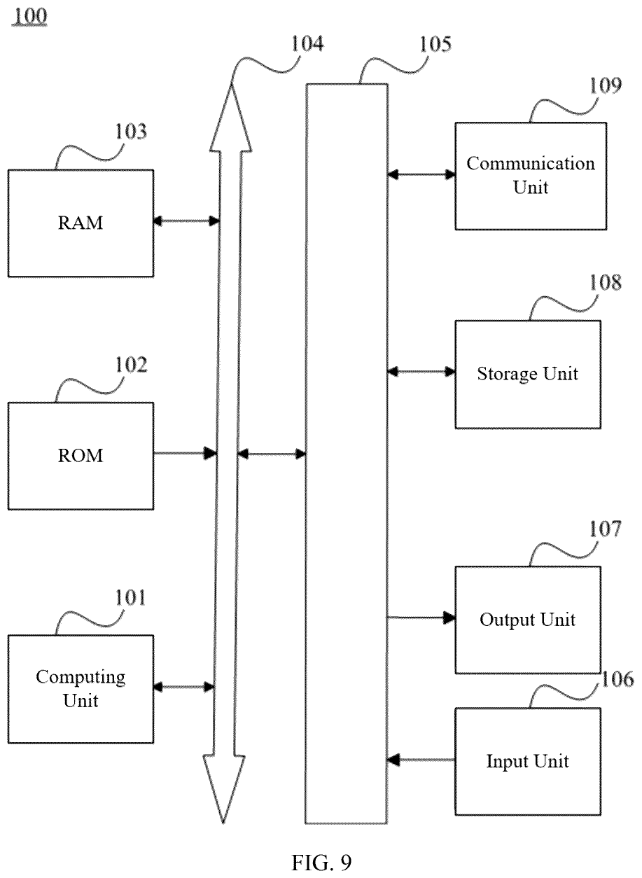

With reference to FIG. 9, a block diagram of the structure of a remote-control device 100 that can be used as the remote-control device of the present disclosure will now be described. The remote-control device 100 includes a computing unit 101, which can execute various appropriate actions and processing according to a computer program stored in ROM 102 or a computer program loaded from a storage unit 108 into RAM 103. Various programs and data required for the operation of the remote-control device 100 can also be stored in RAM 103. The computing unit 101, ROM 102, and RAM 103 are connected to each other via a bus 104. An input/output (I/O) interface 105 is also connected to the bus 104.

A plurality of components in the remote-control device 100 are connected to the I/O interface 105, including: an input unit 106, an output unit 107, a storage unit 108, and a communication unit 109. The input unit 106 may be any type of device capable of inputting information into the remote-control device 100, and the input unit 106 may receive input digital or character information, as well as generate key signal input related to the settings and/or function control of the holder of the remote-control device 100, and may include but is not limited to a mouse, keyboard, touch screen, trackpad, trackball, joystick, microphone, and/or remote controller. The output unit 107 may be any type of device capable of presenting information, and may include but is not limited to a display, speaker, video/audio output terminal, vibrator, and/or printer. The storage unit 108 may include but is not limited to a magnetic disk, optical disk. The communication unit 109 allows the remote-control device 100 to exchange information/data with other devices via a computer network such as the Internet and/or various telecommunication networks, and may include but is not limited to a modem, network card, infrared communication device, wireless communication transceiver and/or chipset, such as a Bluetooth™ device, WiFi device, WiMax device, cellular communication device, and/or the like.

The computing unit 101 may be various general-purpose and/or special-purpose processing components with processing and computing capabilities. Some examples of the computing unit 101 include but are not limited to a central processing unit (CPU), graphics processing unit (GPU), various dedicated artificial intelligence (AI) computing chips, various computing units running machine learning model algorithms, digital signal processors (DSP), and any suitable processor, controller, microcontroller, etc. The computing unit 101 executes the various methods and processing described above. For example, in some embodiments, the above methods may be implemented as computer software programs, which are tangibly contained in a machine-readable storage medium, such as the storage unit 108. In some embodiments, part or all of the computer program may be loaded and/or installed onto the remote-control device 100 via the ROM 102 and/or the communication unit 109. When the computer program is loaded into the RAM 103 and executed by the computing unit 101, one or more steps of the methods described above may be performed. Alternatively, in other embodiments, the computing unit 101 may be configured to perform the above methods in any other suitable manner (for example, by means of firmware).

The remote-control device 100 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the above methods.

Those skilled in the art, in view of the specification and practice of the application disclosed herein, will readily conceive other embodiments of the application. The present disclosure is intended to cover any variations, uses, or adaptations of the application, which follow the general principles of the application and include known or customary technical means in the art not disclosed herein. The specification and embodiments are to be regarded as exemplary only, and the true scope and spirit of the application are indicated by the claims.

It should be understood that the application is not limited to the precise structure already described and shown in the drawings, and various modifications and changes can be made without departing from its scope. The scope of the application is limited only by the appended claims.

### INDUSTRIAL APPLICABILITY

In the UAV control method, remote-control device, system, and storage medium provided by the embodiments of the present disclosure, after entering the selfie stick mode, the position of the UAV is adjusted via a somatosensory operation so that the UAV can capture images from different positions, and the desired image can be captured by controlling the UAV without learning the operation method of the UAV, thereby improving the selfie result.

What is claimed is:

1. A method for controlling an unmanned aerial vehicle (UAV), comprising:
entering a selfie stick mode for the UAV in response to a first operation of a remote-control device; and
in the selfie stick mode, in response to a somatosensory operation of the remote-control device, controlling the UAV to adjust a position based on the somatosensory operation, wherein the position is a position of the UAV relative to a holder of the remote-control device.

2. The method according to claim 1, wherein controlling the UAV to adjust the position based on the somatosensory operation of the remote-control device in response to the somatosensory operation of the remote-control device comprises:
controlling the UAV to move from an initial position to a target position in response to the somatosensory operation of the remote-control device, the initial position being a position of the UAV before the somatosensory operation, the target position being a position of the UAV pointed to when the somatosensory operation stops,
wherein a trajectory of moving from the initial position to the target position is a curved trajectory.

3. The method according to claim 2, wherein the curved trajectory is part of a spherical trajectory, a sphere center of the spherical trajectory is a position of the holder of the remote-control device, and a radius of the spherical trajectory is a distance between the UAV and the holder of the remote-control device.

4. The method according to claim 2, wherein controlling the UAV to move from the initial position to the target position in response to the somatosensory operation of the remote-control device comprises:
controlling the UAV to follow the somatosensory operation of the remote-control device along the curved trajectory from the initial position to the target position in response to the somatosensory operation of the remote-control device, wherein a relative rotation angle of the UAV and the remote-control device remains unchanged.

5. The method according to claim 2, wherein controlling the UAV to move from the initial position to the target position in response to the somatosensory operation of the remote-control device comprises:
when the somatosensory operation is a rotation operation of the remote-control device on a target plane, controlling the UAV to move along the curved trajectory on the target plane or a plane parallel to the target plane.

6. The method according to claim 2, wherein controlling the UAV to move from the initial position to the target position in response to the somatosensory operation of the remote-control device comprises:
determining real-time relative pose information corresponding to the remote-control device during the somatosensory operation;
determining a real-time control quantity corresponding to the UAV based on the real-time relative pose information; and
controlling the UAV to move along the curved trajectory to a position corresponding to the real-time control quantity based on the real-time control quantity.

7. The method according to claim 1, further comprising:
in the selfie stick mode, in response to a movement operation of the remote-control device, controlling the UAV to move following the movement operation of the remote-control device, and maintaining a distance between the UAV and the remote-control device unchanged during the movement operation.

8. The method according to claim 1, further comprising:
in the selfie stick mode, in response to a composite operation of the remote-control device, controlling the UAV to perform an adjustment of the position and a distance between the UAV and the holder of the remote-control device simultaneously based on the composite operation, and maintaining a relative rotation angle of the UAV and the remote-control device unchanged during the adjustment, while maintaining the distance between the UAV and the remote-control device unchanged, wherein the composite operation comprises a somatosensory operation and a movement operation.

9. The method according to claim 1, further comprising:
in response to a pointing operation of the remote-control device, controlling the UAV to move to a position pointed by the pointing operation.

10. The method according to claim 1, wherein the first operation comprises at least one of a sliding operation of a first sliding key in the remote-control device, a rolling operation of a first rolling key in the remote-control device, a pressing operation of a first pressing key in the remote-control device, a first clicking operation of a screen in the remote-control device, a first touch operation of the remote-control device, a first swing operation of the remote-control device, or a first voice operation of the remote-control device.

11. The method according to claim 1, further comprising:
in the selfie stick mode, in response to a second operation of the remote-control device, adjusting a distance between the UAV and the holder of the remote-control device.

12. The method according to claim 1, further comprising:
in the selfie stick mode, in response to a third operation of the remote-control device, switching the selfie stick mode to another mode based on the third operation, the another mode being a mode other than the selfie stick mode.

13. The method according to claim 1, further comprising:
in the selfie stick mode, determining a view-finding angle of view of the UAV; and
performing view-finding and shooting based on the view-finding angle of view.

14. A remote-control device, comprising a memory and a processor, wherein the memory stores a computer program, and when instructions of the computer program are executed by the processor, the processor is configured to:
control an unmanned aerial vehicle (UAV) to enter a selfie stick mode in response to a first operation of the remote-control device; and
in the selfie stick mode, control the UAV to adjust a position based on a somatosensory operation of the remote-control device, the position being a position of the UAV relative to a holder of the remote-control device.

15. The remote-control device according to claim 14, wherein the processor is further configured to:
control the UAV to move from an initial position to a target position in response to the somatosensory operation of the remote-control device, the initial position being a position of the UAV before the somatosensory operation, and the target position being a position of the UAV pointed to when the somatosensory operation stops,
wherein a trajectory of moving from the initial position to the target position is a curved trajectory.

16. The remote-control device according to claim 15, wherein the curved trajectory is a part of a spherical trajectory, a sphere center of the spherical trajectory is a position of the holder of the remote-control device, and a radius of the spherical trajectory is a distance between the UAV and the holder of the remote-control device.

17. The remote-control device according to claim 14, wherein the processor is further configured to:
in the selfie stick mode, in response to a movement operation of the remote-control device, control the UAV to move following the movement operation of the remote-control device, and maintain a distance between the UAV and the remote-control device unchanged during the movement operation.

18. The remote-control device according to claim 14, wherein the processor is further configured to:
in the selfie stick mode, in response to a composite operation of the remote-control device, control the UAV to perform an adjustment of the position and a distance between the UAV and the holder of the remote-control device simultaneously based on the composite operation, and maintain a relative rotation angle of the UAV and the remote-control device unchanged during the adjustment, while maintaining the distance between the UAV and the remote-control device unchanged, wherein the composite operation comprises a somatosensory operation and a movement operation.

19. The remote-control device according to claim 14, wherein the processor is configured to:
in response to a pointing operation of the remote-control device, control the UAV to move to a position pointed by the pointing operation.

20. The remote-control device according to claim 14, wherein the first operation comprises at least one of a sliding operation of a first sliding key in the remote-control device, a rolling operation of a first rolling key in the remote-control device, a pressing operation of a first pressing key in the remote-control device, a first clicking operation of a screen in the remote-control device, a first touch operation of the remote-control device, a first swing operation of the remote-control device, or a first voice operation of the remote-control device.

21. The remote-control device according to claim 14, wherein the processor is configured to:
in the selfie stick mode, in response to a second operation of the remote-control device, adjust a distance between the UAV and the holder of the remote-control device.

22. An unmanned aerial vehicle (UAV) control system, comprising a remote-control device and a UAV,
wherein the remote-control device is configured to send a first control signal to the UAV in response to a first operation of the remote-control device, and in a selfie stick mode, send a second control signal to the UAV in response to a somatosensory operation of the remote-control device; and
wherein the UAV is configured to receive the first control signal and the second control signal and enter the selfie stick mode based on the first control signal, and in the selfie stick mode, adjust a position based on the second control signal, the position being a position of the UAV relative to a holder of the remote-control device.
